(19) United States
(12) Patent Application Publication
(10) Pub. No.: US 2022/0001596 A1
(43) Pub. Date: Jan. 6, 2022

(54) OPACIFYING AGENT APPLICATION IN THREE-DIMENSIONAL PRINTING

(71) Applicant: Hewlett-Packard Development Company, L.P., Spring, TX (US)

(72) Inventors: Aja Hartman, Palo Alto, CA (US); Alexandra Ju, Palo Alto, CA (US); Mary G. Baker, Palo Alto, CA (US); Lihua Zhao, Palo Alto, CA (US); Howard S. Tom, Palo Alto, CA (US); Melanie M. Gottwals, Palo Alto, CA (US); Ingeborg Tastl, Palo Alto, CA (US)

(73) Assignee: Hewlett-Packard Development Company, L.P., Spring, TX (US)

(21) Appl. No.: 17/311,978

(22) PCT Filed: Dec. 14, 2018
(86) PCT No.: PCT/US2018/065806

§ 371 Date: Jun. 8, 2021

(51) Int. Cl. B29C 64/106; B29C 64/209; B29C 64/307; B33Y 10/00; B33Y 30/00

(52) U.S. Cl. CPC B29C 64/106; B29C 64/209; B33Y 30/00; B33Y 10/00; B29C 64/307

(57) ABSTRACT

A three-dimensional printing system includes a controller to instruct a fusing agent distributor to selectively apply a fusing agent to a first region of a layer of build material. The controller also determines a subset of voxels in the layer of build material to provide an opacifying agent based on an opacity value of an opacified region of an object to be generated and instructs an opacifying agent distributor to apply the opacifying agent to the determined subset of voxels.

### BACKGROUND

Some three-dimensional printing systems generate 3D objects by selectively solidifying successive layers of a build material formed on a movable build platform. Some such systems, for example, selectively apply, or print, an energy absorbent fusing agent onto a formed layer of build material based on a 3D object model of the object to be generated. Energy is then applied, from a suitable energy source, to the layer of build material which causes those portions of the build material layer on which fusing agent was applied to heat up sufficiently to melt, sinter, or otherwise fuse together, thereby forming a layer of a 3D object being generated. The wavelengths of energy absorbed by the fusing agent may be generally matched to the wavelengths emitted by the energy source. For example, systems may use infrared or ultra-violet energy to fuse the build material.

### BRIEF DESCRIPTION OF THE DRAWINGS

Examples will now be described, by way of non-limiting example, with reference to the accompanying drawings, in which:

FIGS. 1A, 1B, and 10 are simplified side view illustrations of a 3D printing system according to one example;

FIGS. 1D is a simplified top view illustration of a 3D printing system according to one example;

FIG. 2 is a block diagram of a 3D printer controller according to one example;

FIGS. 3A, 3B, 3C, 3D, and 3E are illustrations of a 3D printed object according to one example.

FIG. 4 is a flow diagram outlining an example method of controlling a 3D printing system according to one example; and

FIG. 5 is a flow diagram outlining an example method of controlling a 3D printing system according to one example.

### DETAILED DESCRIPTION

In a powder-based 3D printing process, build material is deposited on a surface of a build platform. A fusing agent is then applied selectively to the powder in areas that are to be fused. Then energy is applied to cause the build material to melt, sinter, or otherwise fuse where the fusing agent was applied.

The process is repeated by applying additional build material in successive layers. The color and/or opacity of a 3D printed object is generally dictated by the properties of a build material and fusing agent applied during printing processes. For example, the build material may be transparent, translucent, or opaque when fused. Adding titanium dioxide or other agents to either the build material or fusing agent can change the properties of a 3D object to become opaque. Certain fusing agents, for instance, have a dark color to absorb more energy from an energy source to promote fusing. Use of such build materials and fusing agents changes the properties of the entire resulting 3D printed object.

However, additional applications of 3D printed technologies can be realized with the variable opacity 3D printing techniques. For example, the use of a variable opacity can enable backlight applications of 3D printed objects such as for marketing, emergency signs, buttons on computers and other devices, keyboards, or the like. As described herein, an opacifying agent may be applied selectively to areas of a build material to change the opacity of a 3D printed object in those areas.

A 3D printing system, as described herein, may apply an opacifying agent to select voxels within a 3D printed object based on a 3D model of the object. The 3D printing system can include a fusing agent distributor and an opacifying agent distributor. For example, the distributors may be printheads to apply the agents to selected voxels within the 3D printed object. The opacifying agent may be an opaque ink distributed through the printhead. For example, the opacifying agent may be an opaque white ink or another color ink that reduces the transmission of light through a final 3D printed object. The opacifying agent may be other print fluids or agents that can be applied to a layer of build material that have opacifying characteristics. In some examples, an opacifying agent may also act as a fusing agent. For example, the opacifying agent may have similar properties to a fusing agent, but it may be opaque as opposed to transparent or translucent. The opacifying agent may be an opaque ink mixed with a fusing agent that causes the build material to fuse, for instance.

Using a printhead or similar distributor to selectively apply the opacifying agent enables voxel level control of the opacity of a 3D printed object. A voxel represents a discrete position within the volume of a 3D object. Each position within the 3D object can be addressed as the respective layer of build material is formed to selectively fuse the build material and change the opacity of the resulting printed object.

A 3D printing system may change the perceived opacity of a printed object in several ways. For example, the opacity of the printed 3D object can be changed by increasing or decreasing the amount of opacifying agent, varying the thickness of an opacified region, varying the distance of an opacified region from a surface, varying the thickness of a region and the distance from a surface, or a combination of opacifying techniques. In some examples, the 3D printing system changes a contone level of an opacifying agent applied by an opacifying agent distributor such as a printhead. The 3D printing system may also change the spacing present between voxels that have opacifying agent applied to adjust the amount of opacifying agent applied.

Based on selected opacified regions, the printed 3D object may display different characteristics. For example, based on a distance from a surface, an opacified region may have varying clarity as to shape and edges. For example, an opacified region near the surface of an object may have a detectable and recognizable shape. An opacified region further from the surface may reduce light transmission, but may not have a recognizable shape. In addition, the thickness and distance from a surface may provide different perceived characteristics based on the direction of observation and the light applied. For example, application of an opacifying agent near one surface of a 3D object may show different features when illuminated from one direction than from another direction.

In some examples, the application of opacifying agent may change the amount of energy required to properly fuse the build material. For example, the opacifying agent may increase or decrease the rate of energy absorption based on reflecting or absorbing the energy applied. Accordingly, the 3D printing system may increase or decrease the amount of fusing agent applied to regions that have an opacifying agent applied to compensate for changes in energy absorption in those regions. In some examples, the 3D printing system may increase or decrease the amount of energy applied to regions that have an opacifying agent applied or may provide an energy source that is not absorbed or reflected by the opacifying agent.

In some examples, a 3D printing system may determine regions to apply fusing agent, opacifying agent, and amounts of each to apply based on a 3D model. For example, a 3D model may be received by the system with areas indicated to have different opacity. Accordingly, the 3D printing system can use the 3D model to determine where to apply the fusing agent to generate the modeled object. The 3D printing system can also determine, based on opacity indicated in the model, voxels within the 3D object to apply an opacifying agent. The 3D printing system may also determine an amount of opacifying agent to apply. For example, the 3D printing system may determine an opacity value for a region based on a 3D object model. The system may then determine an amount of opacifying agent to apply based on the opacity value. In some examples, the 3D printing system may determine a contone level, a density of voxels to opacify, or other characteristics of voxels to generate the opacity value specified by the 3D model.

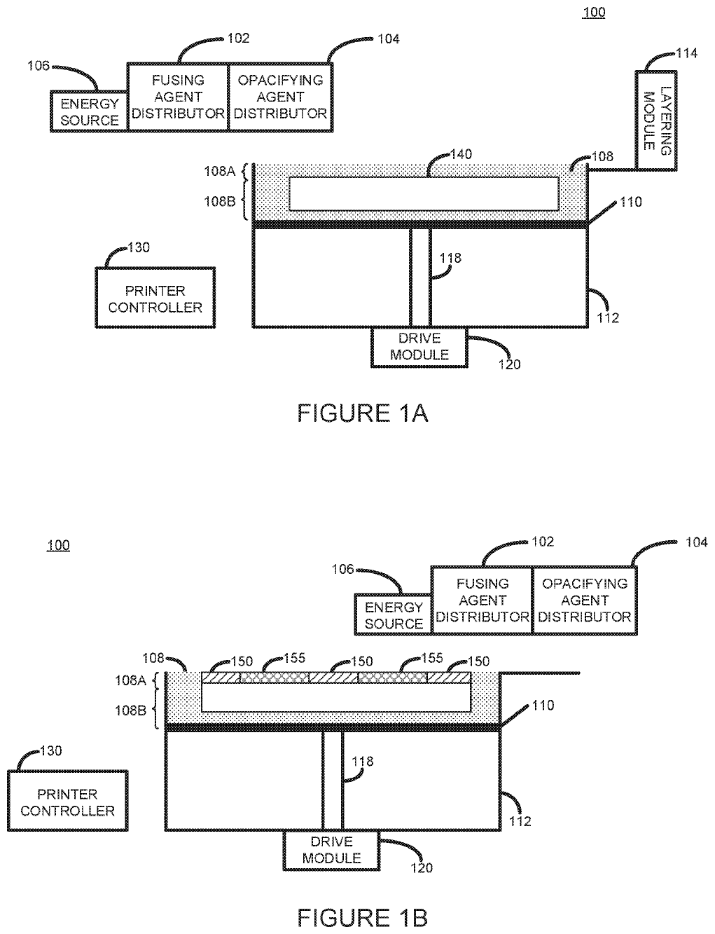

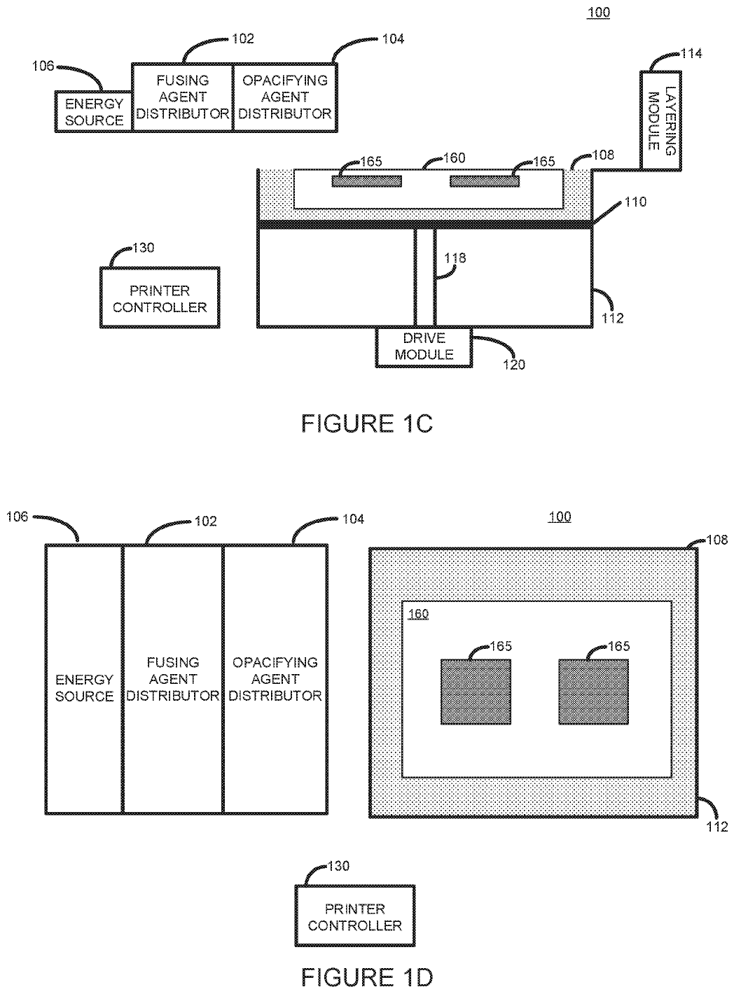

FIG. 1A shows a simplified side view of a three-dimensional (3D) printing system 100 according to one example. For clarity, not all elements of a complete 3D printing system are shown.

The example 3D printing system 100 comprises a carriage (not shown) on which is mounted an energy source 106, a fusing agent distributor 102, and an opacifying agent distributor 104. The carriage, and hence the fusing agent distributor 102, the opacifying agent distributor 104, and the energy source 106, is movable across a build platform 110 having build material 108 applied by a layering module 114. The fusing agent distributor 102 may apply respective agents to portions of the build material 108 to enable melting, sintering, or other fusing of the build material 108. The opacifying agent distributor 104 may also selectively apply an opacifying agent to the build material to change opacity characteristics of selected voxels within the build material.

In some examples, the fusing agent distributor 102 and opacifying agent distributor 104 may be printheads that apply a liquid fusing agent or opacifying agent to a build material 108 to generate a 3D printed object. For example, the opacifying agent distributor 104 and fusing agent distributor 102 may have multiple inkjets that provide respective agents across the build platform. For example, the elements of the fusing agent distributor 102 and opacifying agent distributor 104 may span the width of the build platform to enable energy and printing agent to be applied to any addressable location on a formed layer of build material.

The fusing agent distributor 102 and opacifying agent distributor 104, may be a thermal inkjet (TIJ) printhead, a piezoelectric printhead, or the like. The fusing agent distributor 102 may print, or apply, drops of an energy absorbing fusing agent to a layer of build material in a pattern based on a 3D object model of a 3D object to be generated by the 3D printing system 100. For example, a 3D object model may be sliced into a series of parallel planes, each slice being represented by a bitmap image representing the portions of each layer of build material to be solidified by the 3D printing system 100. In one example, those portions may represent portions of a layer of build material to which a fusing agent is to be applied.

Similar to the fusing agent distributor 102, the opacifying agent distributor 104 may print, or apply, drops of an opacifying agent to a layer of build material in a pattern based on the 3D object model. For example, slices of the 3D object model may include bitmap image data representing portions of each layer of build material to opacify. The portions indicated may represent portions of a layer of build material to which an opacifying agent is to be applied.

In the example shown, applying fusing energy from energy source 106 causes portions of the layer of build material on which fusing agent was applied to heat up sufficiently to melt, sinter, or otherwise fuse, to form a layer of the 3D object being generated. Portions of the layer of build material on which fusing agent was not applied generally will not heat up sufficiently to melt, sinter, or fuse.

The energy source 106 may be any suitable energy source, such as a halogen lamp, that may be used to apply a generally uniform amount of energy to each layer of build material as the energy source 106 is moved over the build platform 110. In some examples, there may be additional energy sources. For example, there may be a leading and trailing energy source on the carriage to preheat the build material and then fuse the build material 108 after the fusing agent distributor 102 applies fusing agent. In some examples, the energy source 106 may be stationary, such as an overhead energy source, rather than moving with the fusing agent distributor 102 and opacifying agent distributor 104.

In the example shown, the fusing agent distributor 102 and opacifying agent distributor 104 selectively print respective agents as they are moved over the build platform 110. The energy source 106 provides sufficient energy to fuse the build material 108 in areas designated by a 3D object model. Those areas also having opacifying agent applied may form a solid layer as well as acquiring opaque characteristics.

In some examples a second energy source (not shown) may be present on the opposite side of the carriage to enable printing bi-directionally across the build platform 110. Accordingly, the trailing energy source (relative to the direction of travel of the carriage) may apply a first level of energy that is to cause sufficient heating and fusing of build material on which fusing agent was applied. In some examples, the leading energy source may apply a level of energy lower than the trailing energy source to warm, or pre-heat, the formed layer of build material to a temperature close to but below the melting temperature of the build material. In another example, warming of the formed layer of build material may be accomplished using a static overhead warming energy source, such as an array of halogen lamps. In some examples, the energy source may move perpendicular to the directions of the printheads in a separate carriage.

The build material layering module 114 may form layers of build material on a build platform 110. For example, the build material layering module may be a recoater which is to spread a volume of build material 108, such as a powdered, particulate, or granular type of build material, over a build platform 110 of a build unit 112. The build material may be any suitable type of build material, including plastic, and ceramic build materials. In some examples, the build material may be selected to form a translucent or transparent object to enable selectively opacifying regions of the material by application of an opacifying agent.

In some examples, the build material layering module 114 may be in the form of a counter-rotating roller, a wiper, blade or any other suitable spreading mechanism. In one example the build material layering module 114 may be a build material dispersion device that directly forms, for example through overhead deposition, a layer of build material on the build platform 110. In some examples, the layering module 114 may move across the build platform 110 in the same direction as the carriage housing the energy source 106, the fusing agent distributor 102, and the opacifying agent distributor 104. In other examples, the layering module 114 may move in a direction perpendicular (or other any other direction) to the movement of the carriage.

The volume of build material 108 may be formed on a build material supply platform by a build material dosing module (not shown). A suitable dosing module may be a hopper, a moveable vane, or any other suitable build material dosing mechanism. The volume of build material 108 may be formed as a volume of build material having a substantially uniform cross-section along the length of the build material supply platform, i.e. extending along the y-axis perpendicular to the plane of the drawing. After spreading, any excess build material may be reused in a reverse spreading process or recovered for use in a subsequent operation.

The build platform 110 is coupled to a support element 118 which is coupled to a drive module 120 to control the build platform. In one example the support element 118 comprises a lead screw threaded through a fixed nut (not shown). Rotation of the lead screw by the drive module 120 thus causes the position of the build platform 110 to vary, depending on the direction of rotation of the lead screw. In another example, the support element 118 may be a hydraulic piston, and the drive module 120 may be a hydraulic drive system to vary the hydraulic pressure within the piston. In use, the drive module 120 is instructed, or is controlled, to lower the build platform 110 by an intended amount. The intended amount may be a predetermined layer thickness that is to be used during a 3D printing build operation.

Operation of the 3D printing system 100 is generally controlled by printer controller 130. For example, the printer controller 130 may control movement and operation of the energy source 106, fusing agent distributor 102, opacifying agent distributor 104, layering module 114, and drive module 120. The printer controller 130 may provide instructions to components of the 3D printing system 100 to construct a 3D object having variable opacity based on a 3D model.

In some examples, the 3D printing system 100 may include additional features not shown such as a detailing agent distributor, additional opacifying agent or fusing agent distributors, or additional energy sources. For example, a detailing agent distributor may apply detailing agent to areas that don't have fusing agent applied to improve resolution and smoothing of the printed object. Additional opacifying agent distributors or other agent distributors may provide different or additional characteristics to the printed object. For example, additional opacifying agents may have different concentrations for different opacifying effects.

FIG. 1A illustrates an example of a stage of a printing process of a 3D object. At this stage in the process, the 3D printing system 100 has applied several layers of build material 108. During previous stages, the 3D printing system formed a portion of a printed object 140 by instructing the fusing agent distributor to apply a fusing agent at selected positions and fusing the build material by applying energy from energy source 106.

The 3D printing system 100 has then applied a new layer of build material 108A above previously applied build material 108B by instructing the layering module 114 to distribute the material across the build platform 110.

The printer controller 130 may then determine instructions for the fusing agent distributor 102 and opacifying agent distributor 104 for a next layer of the printing process. For example, the printer controller may determine voxels to apply fusing agent and voxels to apply opacifying agent based on the model. In some examples, the printer controller may also determine an amount of fusing agent or opacifying agent to apply based on the model. For example, the printer controller may increase a contone level of the opacifying agent to increase opacity. The printer controller may also increase or decrease an amount of fusing agent applied to improve the consistency of fusing across regions. For example, by applying different amounts of fusing agent to regions with opacifying agent applied than regions without opacifying agent applied.

FIG. 1B illustrates an example of a stage of a printing process of a 3D object. The 3D printing system 100 in FIG. 1B may be the same or similar to the 3D printing system 100 as shown in FIG. 1A. For example, 3D printing system 100 in FIG. 1B may be a next stage after the processing shown in FIG. 1A. As shown, the printer controller 130 instructed the fusing agent distributor 102 and the opacifying agent distributor 104 to selectively apply fusing agent and opacifying agent. The regions 150 are regions of build material 108 in the most recently applied layer of build material 108A where fusing agent has been applied. The regions 155 are regions of build material 108 in the most recently applied layer of build material 108A where opacifying agent has been applied. In some examples, the regions 155 may have had both a fusing agent and an opacifying agent applied. Accordingly, the printer controller 130 may instruct the fusing agent distributor 102 and the opacifying agent distributor 104 to apply respective agents in those regions. The carriage holding the fusing agent distributor 102, the opacifying agent distributor 104 and energy source 106 may be moved across the surface of the build unit 112 to enable application of the agents.

As the carriage is moved across the build unit 112, the energy source 106 may also provide energy to melt, sinter, or otherwise fuse build material that has a fusing agent applied. For example, the regions 150 and 155 having fusing agent, opacifying agent, or a combination applied may be fused by the energy source 106. In some examples, additional energy sources may also be used to provide energy for fusing. There may be a second energy source on the other side of the carriage to provide pre-heating energy for instance. Such configurations may also enable bi-directional printing of the 3D object

While shown as regions within a layer being printed by a 3D printing system 100, a printer controller may print fusing agent or opacifying agent at particular voxels within a build material 108 to create particular properties for those voxels. For example, the regions 155 with opacifying agent applied may have opacifying agent applied at varying contone levels or agent density to create varying degrees of opacity after fusing. In some examples, the printer controller may also vary the amount of fusing agent to account for changes resulting from application of the opacifying agent.

FIG. 10 illustrates an example of a stage of a printing process of a 3D object. The 3D printing system 100 in FIG. 10 may be the same, or similar to, the 3D printing system 100 as shown in FIGS. 1A-1B. For example, 3D printing system 100 in FIG. 1C may be a stage after the processing shown in

FIG. 1B. As shown, a fused area 160 has been formed in regions where a fusing agent has been applied by a fusing agent distributor 102. In addition, opacified regions 165 are generated where an opacifying agent has been applied. Additional layers of build material 108 may be applied and the printer controller 130 may provide instructions to the fusing agent distributor 102, the opacifying agent distributor 104, and the energy source 106 to selectively apply and fuse layers of build material 108 with specified opacity characteristics on a voxel level of granularity.

FIG. 1D illustrates an example of a stage of a printing process of a 3D object. The 3D printing system 100 in FIG. 10 may be the same, or similar to, the 3D printing system 100 as shown in FIGS. 1A-1C. For example, 3D printing system 100 in FIG. 1D may be a top down view of the 3D printing system 100 shown from the side in FIGS. 1A-1C. As shown in FIG. 1 D, the opacifying agent distributor 104, fusing agent distributor 102 and energy source 106 span the width of a build unit 112. In some examples, the energy source 106, the fusing agent distributor 102, or the opacifying agent distributor 104 may span less than the width of the build unit 112. Accordingly, the carriage may move in a path across the build material 108 in 2 dimensions to apply opacifying agent and fusing agent according to a 3D model.

The various regions of build material 108, a fused region 160, and opacified regions 165 may be as described with reference to FIG. 1C above. The fused region 160 may be transparent or translucent with opacity determined by the build material and fusing agent after fusing. The opacity of the opacified region 165 may be determined by the type of opacifying agent, the concentration of opacifying agent, as well as how it was applied to the build material 108. For example, the printer controller 130 may change the amount of opacifying agent applied in the opacified region 165 by changing the contone level, or how many drops of the opacifying agent are applied within the opacified region 165. To generate different opacity levels within 3D printed object, the 3D printing system 100 may apply different amounts of opacifying agents in various subregions of a layer or various layers in a printing process. The printer controller 130 may also change the opacity of the opacified region 165 based on the depth and location of the opacified region 165 within the fused region 160. For example, the opacified region 165 may be placed closer to a surface of the fused region, have varying thickness, or have other characteristics to change the opacity of the opacified region 165.

In some examples, the build unit 112 may be integrated into the 3D printing system 100. In other examples, the build unit 112 may be a removable element that may be inserted into the 3D printing system 100 so that a 3D object or objects may be generated in the build unit 112. For example, the printer controller 130, the fusing agent distributor 102, the opacifying agent distributor 104, the energy source 106, and the layering module 114 may be part of a 3D printing system that accepts a build unit 112 to print a 3D object. In various implementations the components of the 3D printing system 100 may be part of other systems or grouped differently between systems.

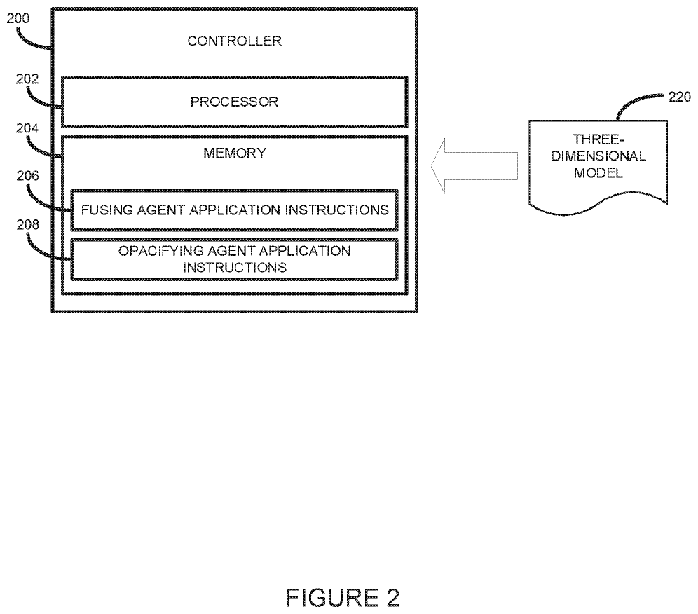

Referring now to FIG. 2, controller 200, according to an example, is shown in greater detail. The controller 200 includes a processor 202, such as a microprocessor or microcontroller. The processor 202 is electronically coupled to a memory 204 via a suitable communications bus (not shown). The memory 204 stores a set of machine-readable instructions that are readable and executable by the processor 202 to control the 3D printing system according to the instructions. Execution of the instructions cause a method of operating the 3D printing system 100 to be performed. For example, any of the example methods described herein may be performed in response to execution of instructions stored in memory 204

In some examples, the memory 204 comprises fusing agent application instructions 206 that, when executed by the processor 202, cause a fusing agent distributor to selectively apply a fusing agent. For example, the fusing agent application instructions 206 may instruct a printhead to apply, or print, a fusing agent to selected portions of a build material as the printhead is moved across a build unit. The fusing agent application instructions 206 may cause the processor 202 to instruct the position of voxels to apply a fusing agent, an amount of fusing agent to apply (such as a contone level), or otherwise control the application of the fusing agent to the build material.

The memory 204 also includes opacifying agent application instructions 208. When executed by the processor 202, the opacifying agent application instructions 208 cause an opacifying agent distributor to selectively apply an opacifying agent. For example, the opacifying agent application instructions 208 may instruct a printhead to apply, or print, an opacifying agent to selected portions of a build material as the printhead is moved across a build unit. The opacifying agent application instructions 208 may cause the processor 202 to instruct the position of voxels to apply a fusing agent, an amount of fusing agent to apply (such as a contone level), or otherwise control the application of the fusing agent to the build material.

In some examples, the opacifying agent application instructions 208 can also cause the processor to determine regions within a layer of build material to apply an opacifying agent. For example, the controller 200 may receive a three-dimensional model 220 and the processor 202 may determine voxels to apply an opacifying agent based on the 3D model 220. The 3D model 220 may be formatted as a 3D object or as a set of layers to be executed by the controller 200. The controller 200 may then determine an amount of opacifying agent to apply to voxels in a layer of build material. In some examples, the fusing agent application instructions 206 may also cause the processor 202 to determine an amount of fusing agent to apply to voxels in a layer of build material based on whether there is an opacifying agent applied to a particular voxel.

In addition to fusing agent application instructions 206 and opacifying agent application instructions 208, the controller 200 may also include additional instructions to control other operations of a 3D printing system. For example, the memory 204 may include instructions that cause the processor 202 to control operation of an energy source, layering module, drive module, detailing agent distributor or other components of a 3D printing system such as the 3D printing system 100 as described with reference to FIGS. 1A-1 D.

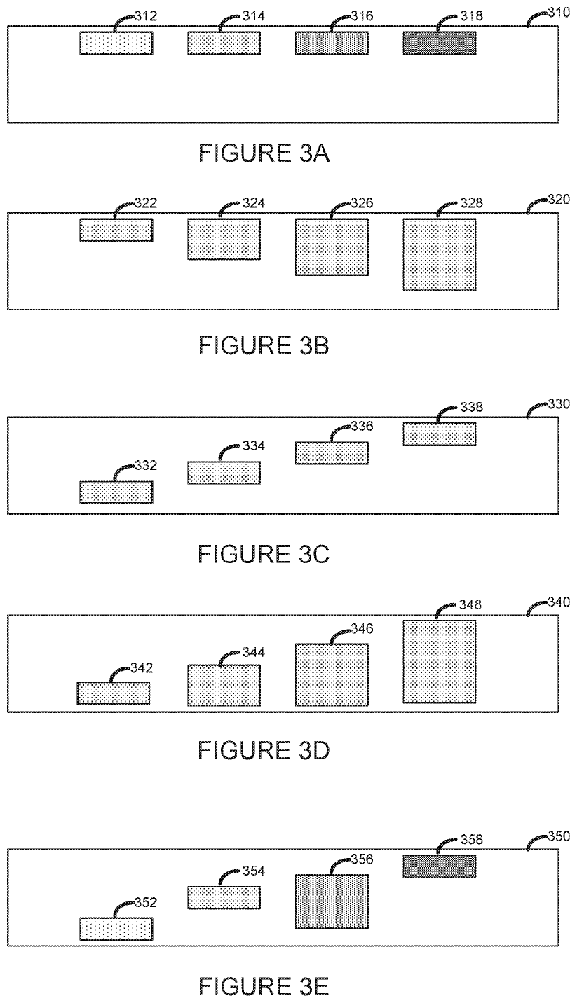

FIGS. 3A-3E illustrate example 3D printed objects having varying opacity based on varying the location or amount of an opacifying agent within the 3D printed object. The example 3D printed objects may be printed by a 3D printing system such as those described with reference to FIGS. 1A-1D.

FIG. 3A illustrates an example 3D printed object 310. The base of the 3D printed object 310 generated by fusing build material with a fusing agent may be transparent or translucent. Within the 3D printed object, the opacity of various opacified regions 312, 314, 316, and 318 is adjusted by changing an amount of opacifying agent applied. For example, a 3D printing system may change a contone level of an opacifying agent printed in identified voxels of the 3D printed object. Accordingly, opacified region 312 may be printed with smaller/fewer drops of an opacifying agent than opacified regions 314, 316, and 318. A 3D printing system may also change the number of voxels within opacified regions 312, 314, 316, and 318 to change the opacity. For example, a higher ration of voxels within an opacified region 312, 314, 316, and 318 may create higher degrees of opacity.

FIG. 3B illustrates an example 3D printed object 320. The base of the 3D printed object 320 generated by fusing build material with a fusing agent may be transparent or translucent. Within the 3D printed object, the opacity of various opacified regions 322, 324, 326, and 328 is adjusted by varying a thickness of opacified regions 322, 324, 326, and 328 from a surface of the printed object 320. For example, a 3D printing system may generate a first opacity in opacified region 322 by setting a thickness from a surface of the printed object 320. Opacified regions 324, 326, and 328 may gradually increase in opacity due to increased thickness of the regions in which the opacifying agent is applied.

FIG. 3C illustrates an example 3D printed object 330. The base of the 3D printed object 330 generated by fusing build material with a fusing agent may be transparent or translucent. Within the 3D printed object, the opacity of various opacified regions 332, 334, 336, and 338 is adjusted by varying the distance of opacified regions 332, 334, 336, and 338 from a surface of the 3D printed object 330. For example, a 3D printing system may generate a first opacity in opacified region 332 by having it a set distance from a surface of the 3D printed object 330. Opacified regions 334, 336, and 338 may gradually increase in opacity due to reduced distance of the regions from the surface.

Accordingly, as there is less material between the surface of the 3D printed object 310 from the opacified regions less light can diffuse through the medium to reduce the perceived opacity.

FIG. 3D illustrates an example 3D printed object 340. The base of the 3D printed object 340 generated by fusing build material with a fusing agent may be transparent or translucent. Within the 3D printed object, the opacity of various opacified regions 342, 344, 346, and 348 is adjusted by varying a thickness of opacified regions 322, 324, 326, and 328 from an opposite surface of the printed object 340. For example, a 3D printing system may generate a first opacity in opacified region 342 by setting a thickness from a surface of the printed object 340. Opacified regions 344, 346, and 348 may gradually increase in opacity due to increased thickness of the regions in which the opacifying agent is applied. Accordingly, the 3D printed object 340 may have similar properties of opacity as 3D printed object 320 as illuminated from another direction.

In addition to the opacity variations shown in FIGS. 3A-3D, FIG. 3E illustrates an example 3D printed object 350 with combinations of opacifying techniques. For example, opacified regions 352 and 354 may have different opacities based on both distance from a surface as well as having different amounts of opacifying agent applied. Accordingly, the opacified regions 352 and 354 may be varied based on a combination of techniques described with reference to FIGS. 3A and 3C. Similarly, opacified regions 356 and 358 include variations to both thickness, distance from surface, and amount of opacifying agent applied. In addition to the examples shown and described, any combination of variations to the size, shape, or amount of opacifying agent in an opacifying region may be used to vary the perceived opacity. In addition, within a single opacifying region, variations of thickness or the amount of opacifying agent may be used to create variation of opacity within a region. For example, gradients of opacity may be generated within an opacifying region.

By way of example and not limitation, Table 1 and Table 2 demonstrate example opacity measurements compared with variations in application of an opacifying agent within 3D printed objects. The example 3D objects have patches with varying amounts of opacifying agent applied as well as varying thicknesses. The thickness and amount of opacifying agent applied to each patch within a plaque is shown in Table 1. In some examples, the amount of opacifying agent may represent a contone level for a printhead applying the agent.

As described in Table 1, 3D object 1 has patches with decreasing thickness and decreasing in the amount of opacifying agent applied. For example, 3D object 1 may be printed using a combination of techniques described with reference to FIG. 3A and 3B above. 3D object 2 has decreasing thickness of patches with a constant amount of opacifying agent applied in the opacified regions as described with reference to FIG. 3B. 3D object 3 and 3D object 4 have decreasing amounts of opacifying agent applied in the opacified regions as described with reference to FIG. 3A. The opacified region in 3D object 4 is thicker than the opacified region in 3D object 3.

TABLE 1

| 3D Object | Patch 1 | Patch 2 | Patch 3 | Patch 4 |
|---|---|---|---|---|
| 1 | 4 mm-255 | 3 mm-170 | 2 mm-85 | 1 mm-0 |
| 2 | 4 mm-255 | 3 mm-255 | 2 mm-255 | 1 mm-255 |
| 3 | 2 mm-255 | 2 mm-170 | 2 mm-85 | 2 mm-0 |
| 4 | 4 mm-255 | 4 mm-170 | 4 mm-85 | 4 mm-0 |

Table 2 shows the example measurements of the percentage of light that is passed through the printed objects. As shown, the thickness of the opacified patch, as well as the amount of opacifying agent applied affect the opacity. Accordingly, with additional variation to the size of a region and amount of opacifying agent, a 3D printing system can generate 3D printed objects with specific opacity characteristics at specified voxels.

TABLE 2

| 3D Object | Patch 1 | Patch 2 | Patch 3 | Patch 4 |
|---|---|---|---|---|
| 1 | 0.81 | 0.98 | 7.31 | 48.76 |
| 2 | 0.75 | 0.74 | 0.77 | 2.12 |
| 3 | 2.08 | 2.64 | 5.52 | 22.60 |
| 4 | 0.71 | 0.67 | 0.70 | 3.00 |

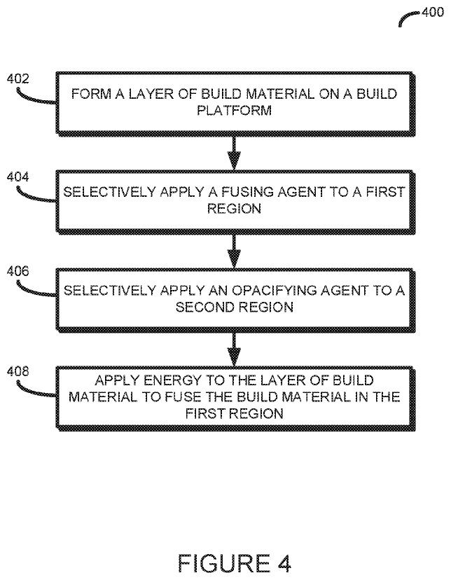

FIG. 4 illustrates an example flow diagram 400 that may be performed by a 3D printing system. For example, the flow diagram may be performed by a 3D printing system as described with reference to FIGS. 1A-1D above. The flow diagram may be performed based on instructions from a controller as described with reference to FIG. 2, for instance.

In block 402, a 3D printing system forms a layer of build material on a build platform. The build material may be a translucent or transparent material that can be fused by the application of a fusing agent. In some examples a build material layering module such as a recoater may apply a volume of build material, such as a powdered, particulate, or granular type of build material, over a build platform of a build unit. The build material may be any suitable type of build material, including plastics, polymers, ceramics, glasses, or the like.

In block 404, the 3D printing system selectively applies a fusing agent to a first region of the layer of build material. For example, a fusing agent distributor may apply a fusing agent through a printhead such as a thermal inkjet printhead, a piezoelectric printhead, or the like. The 3D printing system may print, or apply, drops of an energy absorbing fusing agent to a layer of build material in a pattern based on a 3D object model of a 3D object. The fusing agent may be a transparent fusing agent, a translucent fusing agent, or low tint fusing agent that absorbs energy to cause the build material to fuse. The fusing agent may absorb energy in one energy spectrum (e.g., IR or UV), but be transparent or translucent in the visible spectrum, for instance. For example, a 3D printing system may apply fusing agent to the layer of build material based on a slice of the 3D model corresponding to the layer.

In block 406, the 3D printing system selectively applies an opacifying agent to a second region of the layer of the build material. For example, an opacifying agent distributor may apply the opacifying agent through a printhead such as a thermal inkjet printhead, a piezoelectric printhead, or the like. The 3D printing system may print, or apply, drops of an opacifying agent to a layer of build material in a pattern based on a 3D object model of a 3D object. For example, a 3D printing system may apply opacifying agent to the layer of build material based on a slice of the 3D model corresponding to the layer. The opacifying agent may be an opaque white ink or other agent that generates an opaque region within fused build material. For example, the opacifying agent may be a latex ink with titanium dioxide to create a white opaque ink. The 3D printing system may apply the opacifying agent to voxels corresponding to the locations to be opacified. In some examples, the 3D printing system may change the amount of opacifying agent applied based on intended opacity. The 3D model may indicate a level of opacity and the 3D printing system may determine a corresponding contone level at which to apply an opaque ink through a printhead, for instance. The 3D printing system may also determine a number or density of voxels in the second region to apply opacifying agent to achieve an opacity specified by the 3D model.

In various examples, a 3D printing system may apply the fusing agent and opacifying agent in either order. In addition, in a 3D printing system that prints bi-directionally across a build unit, the agents may be applied in one order in one direction and the opposite in the other direction. Furthermore, the amount of fusing agent may be applied differently based on the application of opacifying agent. For example, the opacifying agent may affect the amount of energy the build material absorbs. Accordingly, an opaque white ink may reduce the amount of energy absorbed and additional fusing agent may be used to compensate. With other fusing agents and opacifying agents, the amount of fusing agent applied may be varied based on the amount of opacifying agent applied.

In some examples, the second region where the opacifying agent is applied is a subregion of the first region where the fusing agent is applied. The opacifying agent may be applied outside the first region, but may not fuse and will be discarded after completion of the 3D printing process. In some examples, the opacifying agent has properties to act as a fusing agent as well. Accordingly, the second region may be separate from the first region and they will each fuse the build material. Furthermore, depending on the desired opacity and agents, a 3D printing system may apply each agent to certain regions even if both have properties that enable fusing of the build material.

In block 408, a 3D printing system applies energy to the layer of build material to fuse the build material in the first region. For example, the energy may be applied with a halogen lamp or other source that applies enough energy to cause the build material to fuse in regions with fusing agent applied.

The processes described with respect to flow diagram 400 may complete a layer of 3D printing within a build unit. Accordingly, a 3D printing system may repeat the processes with successive layers to generate a completed 3D printed object having a shape with opaque regions as specified by a 3D object model. In various implementations, the processes shown in FIG. 4 may be performed in a different order. In addition, in implementing the flow diagram 400, a 3D printing system may perform fewer or additional processes than shown. For example, the 3D printing system may apply additional agents to improve 3D printing or apply additional characteristics to regions or voxels of the 3D object.

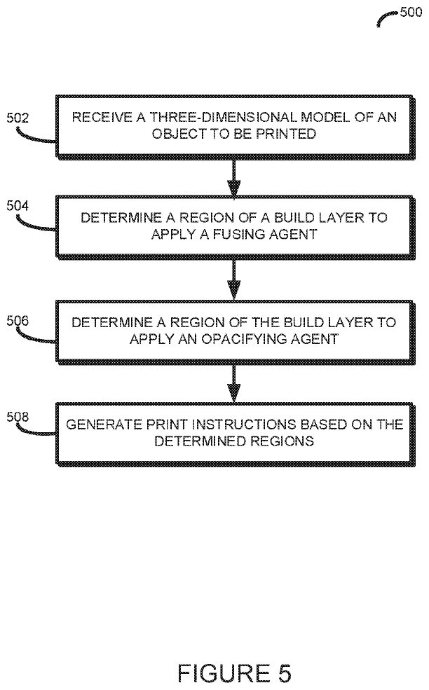

FIG. 5 illustrates an example flow diagram 500 that may be performed by a 3D printing system or controller to determine voxels to apply fusing agent and opacifying agent. Beginning in block 502 a 3D printing system receives a three-dimensional model of an object to be printed. The 3D object model may include any representation of a 3D object. For example, slices of the 3D object model may include data indicating the size and shape of the object as well as regions to have various opacity characteristics.

In block 504, the 3D printing system determines a region of a build layer to apply a fusing agent. For example, the 3D printing system may generate a two-dimensional bitmap of a cross-section of the 3D object model where the bitmap represents the areas to apply a fusing agent. The 3D printing system may also determine an amount of fusing agent to apply at the voxels indicated in the bitmap.

In block 506, the 3D printing system determines a region of a build layer to apply an opacifying agent. For example, the 3D printing system may generate a two-dimensional bitmap of a cross-section of the 3D object model where the bitmap represents the areas to apply an opacifying agent. The 3D printing system may also determine an amount of opacifying agent to apply at the voxels indicated in the bitmap. For example, the 3D model may indicate an opacity for a region and the 3D printing system may determine contone levels or density of voxels in which to apply an opacifying agent.

In block 508, the 3D printing system generates print instructions based on the determined regions. For example, the instructions may be performed by a controller that instructs energy sources, layering modules, fusing agent distributors, and opacifying agent distributors of the 3D printing system.

It will be appreciated that examples described herein can be realized in the form of hardware, software or a combination of hardware and software. For example, the printer controller 130 described in FIG. 1A-1 D or controller 200 described in FIG. 2 may be implemented in a combination of hardware or software. Any such software may be stored in the form of volatile or non-volatile storage such as memory 204 described with reference to FIG. 2. For example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. Accordingly, some examples provide a program comprising code for implementing a system or method as claimed in any preceding claim and a machine-readable storage storing such a program.

The features disclosed in this specification (including any accompanying claims, abstract and drawings), and/or the operations or processes of any method or process so disclosed, may be combined in any combination, except combinations where at least some of such features and/or processes are mutually exclusive.

Each feature disclosed in this specification (including any accompanying claims, abstract, and drawings), may be replaced by alternative features serving the same, equivalent or similar purpose, unless expressly stated otherwise. Thus, unless expressly stated otherwise, each feature disclosed is an example of a generic series of equivalent or similar features.

1. A three-dimensional printing system comprising a controller to:
instruct a fusing agent distributor to selectively apply a fusing agent to a first region of a layer of build material;
determine a subset of voxels in the layer of build material to apply an opacifying agent based on an opacity value of an opacified region of an object to be generated; and
instruct an opacifying agent distributor to apply the opacifying agent to the determined subset of voxels.

2. The three-dimensional printing system of claim 1, wherein the controller is further to instruct the opacifying agent distributor to adjust an amount of the opacifying agent to apply based on the opacity value.

3. The three-dimensional printing system of claim 2, wherein to determine the opacity value for the subset of voxels, the controller is further to:
receive a three-dimensional model of the object to be generated; and
determine, based on the three-dimensional model, the amount of the opacifying agent to apply for the subset of voxels.

4. The three-dimensional printing system of claim 1, wherein the controller is further to determine the subset of voxels in the layer of build material based on a three-dimensional model of the object to generate.

5. The three-dimensional printing system of claim 1, wherein the controller is further to:
instruct the fusing agent distributor to selectively apply the fusing agent to additional layers of build material;
instruct the opacifying agent distributor to selectively apply the opacifying agent to the additional layers of build material; and
control an energy source to fuse the build material having fusing agent applied to generate a three-dimensional object with a selectively opacified region.

6. The three-dimensional printing system of claim 1, wherein to instruct the fusing agent distributor to selectively apply the fusing agent the controller is further to instruct the fusing agent distributor to apply the fusing agent in the first region at a first contone level and to apply the fusing agent in a second region at a second contone level, wherein the second region comprises the determined subset of voxels.

7. The three-dimensional printing system of claim 1, wherein the fusing agent distributor is a first printhead to apply a transparent or translucent fusing agent and the opacifying agent distributor is a second printhead to apply an opaque white ink.

8. A method comprising:
forming a layer of build material on a build platform;
selectively applying a fusing agent to a first region of the layer of build material;
determining a second region of the layer to apply an opacifying agent based on an opacity value of an opacified region of an object to be printed, wherein the second region is a subregion of the first region; and
selectively applying the opacifying agent to the second region of the layer of build material; and
applying, with an energy source, energy to the layer of build material to fuse the layer of build material in the first region.

9. The method of claim 8, further comprising:
receiving, by a controller, a three-dimensional model of the object to be printed; and
determining, by the controller, based on the three-dimensional model, an amount of opacifying agent to apply in the second region.

10. The method of claim 8, wherein selectively applying the opacifying agent comprises providing an opaque white ink via a printhead to the layer of build material.

11. The method of claim 8, wherein selectively applying the opacifying agent comprises adjusting an amount of the opacifying agent to apply based on the opacity value.

12. The method of claim 8, further comprising:
forming a second layer of build material on the build platform;
selectively applying the fusing agent to a third region of the second layer of build material;
selectively applying the opacifying agent to a fourth region of the second layer of build material; and
applying, with the energy source, energy to the second layer of build material to fuse the second layer of build material in the third region.

13. A three-dimensional printing system comprising:
a build material layering system to form a layer of build material on a build platform;
a fusing agent distributor to selectively apply a fusing agent to a first region of the layer of build material;
an opacifying agent distributor to selectively apply an opacifying agent to a second region of the layer of build material based on an opacity value of an opacified region of an object to be generated, wherein the second region is a subset of the first region;
an energy source to apply energy to the layer of build material to fuse the build material in the first region and the second region; and
a controller to instruct the build material layering system, the fusing agent distributor, the opacifying agent distributor, and the energy source to generate a three-dimensional object.

14. The three-dimensional printing system of claim 13, wherein the controller is further to instruct the opacifying agent distributor to apply the opacifying agent at a first selected contone level in a first subregion of the second region and a second selected contone level in a second subregion of the second region.

15. The three-dimensional printing system of claim 13, wherein the fusing agent distributor comprises a first printhead to apply a transparent or translucent agent and the opacifying agent distributor comprises a second printhead to apply an opaque white ink.
